(19) United States
(12) Patent Application Publication
(10) Pub. No.: US 2017/0001867 A1
(43) Pub. Date: Jan. 5, 2017

(54) METHOD FOR PRODUCING GRAPHITE FILM

(71) Applicant: KANEKA CORPORATION, Osaka-shi, Osaka (JP)

(72) Inventors: Motoaki KOBAYASHI, Settsu-shi (JP); Yasushi NISHIKAWA, Settsu-shi (JP); Takashi INADA, Settsu-shi (JP); Yusuke OHTA, Settsu-shi (JP); Satoshi KATAYAMA, Settsu-shi (JP); Makoto KUTSUMIZU, Settsu-shi (JP)

(73) Assignee: KANEKA CORPORATION, Osaka-shi, Osaka (JP)

(21) Appl. No.: 15/031,430

(22) PCT Filed: Nov. 28, 2014
(86) PCT No.: PCT/JP2014/081610

§ 371 Date: Apr. 22, 2016

(30) Foreign Application Priority Data
Nov. 28, 2013 (JP) 2013-246366

(51) Int. Cl. C01B 31/04

(52) U.S. Cl. CPC C01B 31/04; C01P 2006/32; C01P 2006/10

(57) ABSTRACT

Provided is a method of producing a graphite film having a high thermal diffusivity, the method including heat-treating, at a temperature of not lower than 2,400° C., a polyimide film or a carbonized film obtained by carbonizing the polyimide film, the polyimide film (i) having a thickness of not less than 34 μm and not more than 42 μm and a birefringence of not less than 0.1000 and (ii) being obtained with use of (a) an acid dianhydride component containing not less than 70 mol % of PMDA and (b) a diamine component containing not less than 70 mol % of ODA.

### TECHNICAL FIELD

The present invention relates to a method of producing a graphite film having a high thermal diffusivity.

### BACKGROUND ART

Graphite films have been used as components for dissipating heat generated by semiconductor elements or other heat generating components that are provided in various electronic or electric devices such as a computer. For example, it is known that a graphite film having excellent mechanical strength and plasticity can be obtained by (i) heat-treating a polymeric film, having a thickness of 75 μm, up to 1,000° C. in a nitrogen gas, (ii) heating a carbonized film, which has been obtained by heat-treating the polymeric film, up to 3,000° C. in an argon atmosphere, and (iii) rolling a graphitized film, which has been obtained by heating the carbonized film (Patent Literature 1).

Further, as a method of producing a graphite film that can be used for electronic devices etc., there have been known many methods in which a polyimide film, which is a material polymeric film, is heat-treated (Patent Literatures 2 through 6).

### CITATION LIST

### Patent Literature

[Patent Literature 1]

Japanese Patent Application Publication Tokukaihei No. 03-075211 (Publication date: Mar. 29, 1991)

[Patent Literature 2]

Japanese Patent Application Publication Tokukai No. 2012-046368 (Publication date: Mar. 8, 2012)

[Patent Literature 3]

Japanese Patent Application Publication Tokukai No. 2003-229336 (Publication date: Aug. 15, 2003)

[Patent Literature 4]

Japanese Patent Application Publication Tokukai No. 2005-314168 (Publication date: Nov. 10, 2005)

[Patent Literature 5]

Japanese Patent Application Publication Tokukai No. 2004-017504 (Publication date: Jan. 22, 2004)

[Patent Literature 6]

Japanese Patent Application Publication Tokukai No. 2010-215441 (Publication date: Sep. 30, 2010)

### SUMMARY OF INVENTION

### Technical Problem

In recent years, a raise in functionality of electronic devices has caused a rapid increase in amount of generated heat. Accordingly, there has been a demand for development of a graphite film having a higher thermal diffusivity.

### Solution to Problem

In order to attain the above object, a method for producing a graphite film in accordance with the present invention includes heat-treating, at a temperature of not lower than 2,400° C., a polyimide film or a carbonized film obtained by carbonizing the polyimide film, the polyimide film having (i) a thickness of not less than 34 μm and not more than 42 μm and (ii) a birefringence of not less than 0.100 and not more than 0.130.

In order to attain the above object, a graphite film in accordance with the present invention has a thickness of not less than 14 μm and not more than 18 μm; a thermal diffusivity of not less than 9.0 cm²/s; and a density of not less than 1.8 g/cm³.

### Advantageous Effects of Invention

According to the method of producing a graphite film of the present invention, it is possible to produce a graphite film having a thermal diffusivity higher than that of a conventional graphite film.

According to the graphite film of the present invention, it is possible to realize a graphite film having (i) a thickness and a density each similar to that of a conventional graphite film and (ii) a thermal diffusivity higher than that of the conventional graphite film.

### DESCRIPTION OF EMBODIMENTS

<Graphite Film>

According to the method of producing a graphite film of the present invention, a graphite film is produced by a polymer thermal decomposition method in which a polyimide film is head-treated under an inactive gas atmosphere or under a reduced pressure. The graphite film produced by the method of the present invention has a high thermal conductivity. Therefore the graphite film is used as a heat dissipating material or a heat dissipating component of, for example, an electronic device.

<Thickness of Graphite Film>

A thickness of the graphite film of the present invention is not particularly limited, provided that the graphite film is one that is produced with use of a polyimide film having a thickness of not less than 34 μm and not more than 42 μm. Note, however, that, in order to be so thin as to be used for a small-sized component, the graphite film has a thickness of not less than 14 μm and not more than 18 μm, preferably of not less than 15 μm and not more than 17 μm, more preferably of 16 μm.

<Thermal Diffusivity in Surface Direction of Graphite Film>

In order to dissipate heat generated from a small-sized electronic device, the graphite film of the present invention has a thermal diffusivity preferably of not less than 9.0 cm²/s, more preferably of not less than 9.3 cm²/s, still more preferably of not less than 9.6 cm²/s.

<Measurement of Thermal Diffusivity in Surface Direction of Graphite Film>

The thermal diffusivity in a surface direction of the graphite film was measured in the following manner. That is, a sample having a size of 4 mm×40 mm was cut out from the graphite film. A thermal diffusivity of the sample was then measured with use of a thermal diffusivity measurement device (“Laser Pit” manufactured by ULVAC-RIKO, Inc.), which employs the light alternating-current method, under an atmosphere of 23° C. and at 10 Hz. Note that a specimen (that is, the sample) was obtained from a portion near a center of a sheet sample (that is, the graphite film).

<Density of Graphite Film>

In order to have an improved property of conveying heat, the graphite film of the present invention has a density preferably of not less than 1.8 g/cm³, more preferably of not less than 1.9 g/cm³. Further, the graphite film of the present invention has a density preferably of not more than 2.09 g/cm³, more preferably of not more than 2.07 g/cm³. This causes the graphite film to unlikely have a fold when being bent and to maintain the thermal diffusivity even in a case where the graphite film is subjected to a process 10 times which process includes (i) bending the graphite film at the middle thereof in a longitudinal direction so that the graphite film has curvature whose radius is 2 mm and whose angle is 90 degrees and (ii) bringing the graphite film back to a flat state.

<Polyimide Film>

The polyimide film used in the present invention has a given thickness and a given birefringence. The polyimide film is generally made from an acid dianhydride component and a diamine component.

<Acid Dianhydride Component from which Polyimide Film is Made>

The acid dianhydride component used in the present invention so as to synthesize polyimide contains pyromellitic acid dianhydride (hereinafter, referred to as “PMDA”). PMDA accounts for not less than 70 mol %, preferably not less than 80 mol %, more preferably not less than 90 mol % of the acid dianhydride component.

Examples of acid dianhydride, other than PMDA, encompass 2,3,6,7-naphthalene tetracarboxylic acid dianhydride, 3,3′,4,4′-biphenyltetracarboxylic acid dianhydride (hereinafter, referred to as “BPDA”), 1,2,5,6-naphthalene tetracarboxylic acid dianhydride, 2,2′,3,3′-biphenyltetracarboxylic acid dianhydride, 3,3′,4,4′-benzophenone tetracarboxylic acid dianhydride, 2,2-bis(3,4-dicarboxyphenyl) propane dianhydride, 3,4,9,10-perylene tetracarboxylic acid dianhydride, 1,1-(3,4-dicarboxyphenyl)ethane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, oxydiphthalic acid dianhydride, bis(3,4-dicarboxyphenyl)sulfone dianhydride, p-phenylene bis(trimellitic acid monoester acid anhydride), ethylenebis(trimellitic acid monoester acid anhydride), bisphenol A bis(trimellitic acid monoester acid anhydride), and analogues thereof. Each of those substances can be mixed at a given ratio.

<Diamine Component to be Used for Making Polyimide Film>

The diamine component used in the present invention so as to synthesize polyimide contains 4,4′-diaminodiphenyl ether (hereinafter, referred to as “ODA”). ODA accounts for not less than 70 mol %, preferably not less than 80 mol %, more preferably not less than 90 mol % of the diamine component. Examples of diamine, other than ODA, encompass p-phenylenediamine (hereinafter, referred to as “PDA”), 4,4′-diaminodiphenyl methane, benzidine, 3,3′-dichlorobenzidine, 4,4′-diaminodiphenyl sulfide, 3,3′-diaminodiphenyl sulfone, 4,4′-diaminodiphenyl sulfone, 3,3′-diaminodiphenyl ether, 3,4′-diaminodiphenyl ether, 1,5-diaminonaphthalene, 4,4′-diaminodiphenyldiethyl silane, 4,4′-diaminodiphenyl silane, 4,4′-diaminodiphenyl ethyl phosphine oxide, 4,4′-diaminodiphenyl N-methylamine, 4,4′-diaminodiphenyl N-phenylamine, 1,3-diaminobenzene, 1,2-diaminobenzene, and analogues thereof. Each of those substances can be mixed at a given ratio.

<Thickness of Polyimide Film>

The polyimide film used in the present invention has a thickness of not less than 34 μm and not more than 42 μm, preferably of not less than 38 μm and not more than 40 μm, more preferably of 38 μm. In a case where the thickness of the polyimide film is not more than 42 μm, the polyimide film is heat-treated uniformly in a thickness direction. This improves the thermal diffusivity. In a case where the thickness of the polyimide film is not less than 34 μm, the polyimide film is prevented from having a surface area in which a defect likely arises while the polyimide film is being heat-treated. This also improves the thermal diffusivity.

<Birefringence of Polyimide Film>

The polyimide film used in the present invention has, in any in-plane directions of the polyimide film, a birefringence preferably of not less than 0.100 and not more than 0.130, more preferably of not less than 0.110 and not more than 0.120. In a case where the birefringence is not less than 0.100, the polyimide film itself has a good intramolecular orientation. When such a polyimide film is graphitized, a graphite film having a good orientation is obtained. It is therefore preferable that the birefringence be not less than 0.100. In a case where the birefringence is not more than 0.130, a graphite film having a small difference between surface crystallinity and inner crystallinity is obtained. It is therefore preferable that the birefringence be not more than 0.130. The term “birefringence” as used in the present invention means a difference between (i) a refractive index in a given in-plane direction of the polyimide film and (ii) a refractive index in the thickness direction.

<Method of Measuring Birefringence of Polyimide Film>

The birefringence of the polyimide film was measured in the following manner with use of a refractive index and film thickness measuring system (model number: 2010 Prism-coupler) manufactured by Metricon Corp. That is, a refractive index was measured in each of a TE mode and a TM mode, under an atmosphere of 23° C. and with use of a light source which emitted light having a wavelength of 594 nm. The birefringence was then calculated in accordance with a formula “(refractive index value measured in TE mode)−(refractive index value measured in TM mode)”. Note that the phrase “any in-plane directions of the polyimide film” means any in-plane directions at angles of, for example, a 0 degree, 45 degrees, 90 degrees, and 135 degrees relative to a direction in which a material is conveyed during production of the polyimide film. Therefore, a sample was set on an apparatus at angles of a 0 degree, 45 degrees, 90 degrees, and 135 degrees, and birefringences were measured at the respective angles. Out of the birefringences, one that had the lowest value was deemed as the birefringence.

<Imidization Method>

As an imidization method by which the polyimide film is obtained, any one of the following methods can be employed: (i) a thermal cure method in which imide-conversion from a polyamide acid, serving as a precursor, into polyimide is carried out by heating the polyamide acid; and (ii) a chemical cure method in which imide-conversion from a polyamide acid, serving as a precursor, into polyimide is carried out with use of (a) a dehydrator typified by acid anhydride such as acetic anhydride and/or (b) an imidization accelerator typified by tertiary amines such as picoline, quinoline, isoquinoline, and pyridine. In a case where the chemical cure method is used, the imidization accelerator is preferably selected from the tertiary amines.

The chemical cure method is particularly preferable because a resultant film (i) is likely to have a low linear expansion coefficient, a high elastic modulus, and a great birefringence and (ii) is capable of being rapidly graphitized at a comparatively low temperature so that it is possible to obtain a graphite film having good quality. In addition, it is particularly preferable to combine the dehydrator and the imidization accelerator because in such a case, a resultant film can have a lower linear expansion coefficient, a greater elastic modulus, and a greater birefringence. In the chemical cure method, imidization reaction more rapidly proceeds, so that it is possible to briefly complete the imidization reaction during heat treatment. Therefore, the chemical cure method is a productively excellent and industrially advantageous method.

<Method of Producing Polyimide Film>

A method of producing the polyamide acid used in the present invention is not particularly limited. The polyamide acid can be produced by, for example, (i) dissolving, in an organic solvent, aromatic acid dianhydride and diamine which are substantially equal to each other in molar quantity and (ii) stirring the organic solvent under a controlled temperature condition until polymerization of the aromatic acid dianhydride and the diamine is completed. The method of polymerizing acid dianhydride and diamine is not particularly limited, but is preferably selected from, for example, the following methods (1) through (5).

(1) A method in which aromatic diamine is (i) dissolved in an organic polar solvent and (ii) reacted with aromatic tetracarboxylic acid dianhydride, substantially equal in molar quantity to the aromatic diamine, so that the aromatic diamine and the aromatic tetracarboxylic acid dianhydride are polymerized.

(2) A method in which (i) in an organic polar solvent, aromatic tetracarboxylic acid dianhydride is reacted with an aromatic diamine compound, having fewer moles than the aromatic tetracarboxylic acid dianhydride, so as to obtain a prepolymer having acid anhydride groups at its both terminals and then (ii) the prepolymer and an aromatic diamine compound, substantially equal in molar quantity to the aromatic tetracarboxylic acid dianhydride, are polymerized.

A specific example of the above method (2) is similar to a method of synthesizing a polyamide acid by (i) synthesizing, with use of diamine and acid dianhydride, a prepolymer having the acid dianhydride at its both terminals and (ii) reacting the prepolymer with diamine different in type from or identical in type to the diamine that has been used to synthesize the prepolymer. Also in the method (2), the aromatic diamine to be reacted with the prepolymer can be aromatic diamine different in type from or identical in type to the aromatic diamine that has been used to synthesize the prepolymer.

(3) A method in which (i) in an organic polar solvent, aromatic tetracarboxylic acid dianhydride is reacted with an aromatic diamine compound, having more moles than the aromatic tetracarboxylic acid dianhydride, so as to obtain a prepolymer having amino groups at its both terminals, (ii) an aromatic diamine compound is further added to the prepolymer, and then (iii) the prepolymer and aromatic tetracarboxylic acid dianhydride are polymerized so that the aromatic tetracarboxylic acid dianhydride is substantially equal in molar quantity to the aromatic diamine compound.

(4) A method in which (i) aromatic tetracarboxylic acid dianhydride is dissolved and/or dispersed in an organic polar solvent, (ii) an aromatic diamine compound is added to the organic polar solvent so that the aromatic diamine compound is substantially equal in molar quantity to the aromatic tetracarboxylic acid dianhydride, and then (iii) the aromatic tetracarboxylic acid dianhydride and the aromatic diamine compound are polymerized.

(5) A method in which, in an organic polar solvent, a mixture, of aromatic tetracarboxylic acid dianhydride and aromatic diamine which are substantially equal in molar quantity to each other, is reacted so as to be polymerized.

Out of those methods, the method (2) or (3), that is, a method in which the polyamide acid is produced by a sequential control (sequence control) that includes production of a prepolymer is preferably employed. Note that the sequential control refers to a technique of controlling a combination of block polymers and/or a connection between block polymer molecules. With the method (2) or (3), (i) it is easier to obtain a polyimide film having a great birefringence and a low liner expansion coefficient, and (ii) by heat-treating this polyimide film, it is easier to obtain a graphite film that is excellent not only in plasticity but also in thermal conductivity.

<Stretch of Polyimide Film>

A step of producing polyimide can include a step of stretching the polyimide film. Here, it is assumed that an average stretch ratio of the film is defined by a formula “(a stretch ratio in a MD direction+a stretch ratio in a TD direction)/2.” In a case where the film is stretched, it is preferable that the average stretch ratio of the film be not less than 0.8 and not more than 1.25. Note that the MD direction refers to a direction in which the film is conveyed, and the TD direction refers to a width direction of the film.

<Carbonization Step>

A carbonization step is a step of obtaining a carbonized film by heat-treating the polyimide film at a temperature of not lower than a room temperature and not higher than 1,600° C. The maximum temperature of heat treatment carried out in the carbonization step is at least not lower than 800° C., preferably not lower than 900° C., more preferably not lower than 1,000° C.

<Graphitization Step>

A graphitization step is a step of obtaining a graphite film by heat-treating the polyimide film or the carbonized film, obtained by carbonizing the polyimide film, at a temperature of not lower than 2,400° C. In the graphitization step, the polyimide film can be heat-treated or alternatively, the carbonized film obtained in the carbonization step can be heat-treated. The graphitization step is carried out under a reduced pressure or in an inactive gas. As the inactive gas, argon or helium is preferably used. The maximum temperature of such heat treatment is not lower than 2,400° C., preferably not lower than 2,600° C., more preferably not lower than 2,800° C. In a case where the maximum temperature of the heat treatment is not lower than 2,400° C., it is possible to obtain a graphite film having a high thermal diffusivity.

<How to Set Film in Carbonization Step and Graphitization Step>

How to set a film in each of the carbonization step and the graphitization step of the present invention is not particularly limited. For example, a single or a plurality of polyimide film(s) or a single or a plurality of carbonized film(s) is/are heat-treated while being sandwiched between carbonaceous sheets. Note here that examples of the carbonaceous sheet encompasses isotropic graphite sheets manufactured by TOYO TANSO CO., LTD. (product names: IG-11, ISEM-3, etc.), C/C composite plates manufactured by TOYO TANSO CO., LTD. (product names: CX-26, CX-27, etc.), extruded graphite plates manufactured by SEC CARBON, LTD. (product names: PSG-12, PSG-332, etc.), and expanded graphite sheets manufactured by TOYO TANSO CO., LTD. (product name: PERMA-FOIL (grade names: PF, PF-R2, PF-UHPL, etc.)).

In a preferred aspect of the method, of the present invention, of producing a graphite film having a high thermal diffusivity, polyimide films and carbonaceous sheets are alternately layered in the carbonization step. Similarly, polyimide films or carbonized films and carbonaceous sheets are alternately layered in the graphitization step.

Alternatively, the polyimide film or the carbonized film can be heat-treated in a state where the polyimide film or the carbonized film is rolled up into a cylinder.

<Temperature of Heat Treatment of Present Invention>

It is assumed that the temperature of the heat treatment (carried out in each of the carbonization step and the graphitization step) of the present invention indicates an actual temperature measured at a center of a heater. Such a heater temperature can be measured with use of a thermocouple in a case where the heater temperature is not higher than 1,200° C. In a case where the heater temperature is higher than 1,200° C., the heater temperature can be measured with use of a radiation thermometer.

<Compression Step>

The graphite film expanded in the graphitization step can be subjected to a compression step. By compressing the graphite film, it is possible to cause the graphite film to have plasticity. The compression step can be carried out by use of, for example, a method of planarly compressing the graphite film or a method of rolling the graphite film with use of a metallic roller or the like. The compression step can be carried out at a room temperature or can be alternatively carried out during the graphitization step.

The present invention can also be configured as below.

The method, of the present invention, of producing a graphite film can be arranged so as to include heat-treating, at a temperature of not lower than 2,400° C., a polyimide film or a carbonized film obtained by carbonizing the polyimide film, the polyimide film (i) having a thickness of not less than 34 μm and not more than 42 μm and (ii) being obtained by the chemical cure method with use of (a) an acid dianhydride component containing not less than 70 mol % of PMDA and (b) a diamine component containing not less than 70 mol % of ODA.

### EXAMPLES

Examples of the present invention will be described below together with Comparative Examples.

(Measurement of Thickness)

In each of the following Examples and Comparative Examples, a polyimide film and a graphite film were obtained. Thicknesses at four corners and a center of each of the polyimide film and the graphite film were measured with use of a micrometer manufactured by Mitutoyo Corp. Note here that the “center” indicates a position of an intersection of (i) a line via which two of the four corners, which two are diagonally located, are connected and (ii) a line via which the other two of the four corners, which two are diagonally located, are connected. Then, an average value of the thicknesses thus measured was regarded as a thickness of the each of the polyimide film and the graphite film.

(Measurement of Density of Graphite Film)

In each of the following Examples and Comparative Examples, a sample having a size of 5 cm×5 cm was punched out from a central portion of the graphite film obtained. Note here that the “central portion” indicates a portion located at the middle in both of width and longitudinal directions of the graphite film. A weight of the sample was then measured. Based on a value of the weight thus measured, a density of the graphite film was calculated in accordance with a formula “density=weight/(area×thickness)”.

(Measurement of Thermal Diffusivity in Surface Direction of Graphite Film which has been Bent)

A thermal diffusivity in a surface direction of the graphite film which had been bent was measured in the following manner. That is, the graphite film was first subjected to a process 10 times which process included (i) bending the graphite film at the middle thereof in the longitudinal direction so that the graphite film had a curvature whose radius was 2 mm and whose angle was 90 degrees and (ii) bringing the graphite film back to a flat state. A portion of the graphite film which portion had had the curvature was then cut into a piece having a size of 4 mm in the longitudinal direction and 40 mm in the width direction. Thereafter, an in-plane thermal diffusivity of the piece was measured.

In a case where an amount of decrease in thermal diffusivity after bending was less than 1.0 cm²/s, the graphite film was evaluated as “good” and marked with a circle. In a case where the amount of decrease was not less than 1.0 cm²/s, the graphite film was evaluated as “poor” and marked with a cross.

(Cure Method)

In the following description, a chemical cure method in which, as a curing agent, acetic anhydride and isoquinoline were added each in an amount of 1 (one) equivalent with respect to a carboxylic acid group contained in a polyamide acid will be simply referred to as a “chemical cure method.” A chemical cure method in which, as a curing agent, acetic anhydride and isoquinoline were added each in an amount of 0.7 equivalent with respect to a carboxylic acid group contained in a polyamide acid will be referred to as a “weak chemical cure method”. A chemical cure method in which, as a curing agent, acetic anhydride and isoquinoline were added each in an amount of 0.5 equivalent with respect to a carboxylic acid group contained in a polyamide acid will be referred to as a “weaker chemical cure method”. A cure method in which heating was carried out without the use of a curing agent will be referred to as a “thermal cure method”.

### Example 1

### Production Method of Polyimide Film

Acid dianhydride composed of 100 mol % of PMDA was dissolved in a dimethylformamide (DMF) solution, in which diamine composed of 100 mol % of ODA was dissolved, so that the acid dianhydride was equal in molar quantity to the diamine. A solution containing 18.5 wt % of a polyamide acid was thus obtained. While this solution was being cooled, an imidization catalyst containing acetic anhydride, isoquinoline, and DMF was added to the solution so as to defoam the solution. Each of the acetic anhydride and the isoquinoline was in an amount of 1 (one) equivalent with respect to a carboxylic acid group contained in the polyamide acid. This mixed solution was then applied on an aluminum foil so that a resultant polyimide film would have a thickness of 34 μm after the mixed solution is dried. A mixed solution layer was thus obtained. The mixed solution layer on the aluminum foil was dried with use of a hot-air oven and a far-infrared heater.

Drying conditions were as follows. That is, the mixed solution layer on the aluminum foil was first dried at 120° C. for 110 seconds in the hot-air oven so as to obtain a gel film having a self-supporting property. The gel film was then removed from the aluminum foil and was fixed to a frame. Thereafter, the gel film was dried by heating the gel film in stages, that is, by heating the gel film at 120° C. for 14 seconds, at 275° C. for 18 seconds, at 400° C. for 19 seconds, and at 450° C. for 22 seconds in the hot-air oven and then heating the gel film at 460° C. for 10 seconds with use of the far-infrared heater. A polyimide film having a thickness of 34 μm (birefringence: 0.115) was thus produced.

<Production Method of Graphite Film>

While the polyimide film having a size of 200 mm×200 mm was being sandwiched between graphite sheets each having a size of 220 mm×220 mm (i.e., the polyimide film and the graphite sheets were being alternately layered), the polyimide film was heated under a nitrogen atmosphere up to 1,000° C. at a temperature increase rate of 2° C./min, and then heat-treated at a temperature of 1,000° C. so as to be carbonized.

After that, a resultant carbonized film was heated up to 2,900° C. (maximum temperature of graphitization) at a temperature increase rate of 2.5° C./min in the following manner. That is, in a case where an ambient temperature fell within a temperature range of a room temperature to 2,200° C., heating was carried out under a reduced pressure. Alternatively, in a case where the ambient temperature fell within a temperature range of not less than 2,200° C., the heating was carried out under an argon atmosphere. The carbonized film was then held at a temperature of 2,900° C. for 30 minutes so as to produce a graphite film. While a single graphite film thus obtained, having a size of 180 mm×180 mm, was being sandwiched between PET films each having a size of 200 mm×200 mm and having a thickness of 400 μm, the graphite film was compressed with use of a compression molding machine.

During this compression treatment, a pressure of 10 MPa was applied to the graphite film (Example 1→cure method: chemical cure method, average stretch ratio: 1.0).

### Example 2

A graphite film was produced in a manner similar to that in Example 1, except that (i) a polyimide film having a thickness of 38 μm was used and (ii) drying conditions were set as follows. That is, a mixed solution layer on an aluminum foil was first dried at 120° C. for 120 seconds in a hot-air oven so as to obtain a gel film having a self-supporting property. The gel film was then removed from the aluminum foil and was fixed to a frame. Thereafter, the gel film was dried by heating the gel film in stages, that is, by heating the gel film at 120° C. for 15 seconds, at 275° C. for 20 seconds, at 400° C. for 22 seconds, and at 450° C. for 25 seconds in the hot-air oven and then heating the gel film at 460° C. for 12 seconds with use of a far-infrared heater. A polyimide film having a thickness of 38 μm (birefringence: 0.115) was thus produced (Example 2→cure method: chemical cure method, average stretch ratio: 1.0).

### Example 3

A graphite film was produced in a manner similar to that in Example 1, except that (i) a polyimide film having a thickness of 40 μm was used and (ii) drying conditions were set as follows. That is, a mixed solution layer on an aluminum foil was first dried at 120° C. for 126 seconds in a hot-air oven so as to obtain a gel film having a self-supporting property. The gel film was then removed from the aluminum foil and was fixed to a frame. Thereafter, the gel film was dried by heating the gel film in stages, that is, by heating the gel film at 120° C. for 16 seconds, at 275° C. for 21 seconds, at 400° C. for 23 seconds, and at 450° C. for 26 seconds in the hot-air oven and then heating the gel film at 460° C. for 13 seconds with use of the far-infrared heater. A polyimide film having a thickness of 40 μm (birefringence: 0.115) was thus produced (Example 3→cure method: chemical cure method, average stretch ratio: 1.0).

### Example 4

A graphite film was produced in a manner similar to that in Example 1, except that (i) a polyimide film having a thickness of 42 μm was used and (ii) drying conditions were set as follows. That is, a mixed solution layer on an aluminum foil was first dried at 120° C. for 135 seconds in a hot-air oven so as to obtain a gel film having a self-supporting property. The gel film was then removed from the aluminum foil and was fixed to a frame. Thereafter, the gel film was dried by heating the gel film in stages, that is, by heating the gel film at 120° C. for 17 seconds, at 275° C. for 22 seconds, at 400° C. for 24 seconds, and at 450° C. for 28 seconds in the hot-air oven and then heating the gel film at 46 for 13 seconds with use of the far-infrared heater. A polyimide film having a thickness of 42 μm (birefringence: 0.115) was thus produced (Example 4→cure method: chemical cure method, average stretch ratio: 1.0).

### Example 5

A graphite film was produced in a manner similar to that in Example 2, except that, in a step, during production of a polyimide film, of adding an imidization catalyst, containing acetic anhydride, isoquinoline, and DMF, so as to defoam a solution containing a polyamide acid, each of the acetic anhydride and the isoquinoline was in an amount of 0.7 equivalent with respect to a carboxylic acid group contained in the polyamide acid. In Example 5, a polyimide film having a thickness of 38 μm (birefringence: 0.104) was produced (Example 5→cure method: weak chemical cure method, average stretch ratio: 1.0).

### Example 6

A graphite film was produced in a manner similar to that in Example 2, except that, in a step, during production of a polyimide film, of adding an imidization catalyst, containing acetic anhydride, isoquinoline, and DMF, so as to defoam a solution containing a polyamide acid, each of the acetic anhydride and the isoquinoline was in an amount of 0.5 equivalent with respect to a carboxylic acid group contained in the polyamide acid. In Example 6, a polyimide film having a thickness of 38 μm (birefringence: 0.100) was produced (Example 6→cure method: weaker chemical cure method, average stretch ratio: 1.0).

### Example 7

A graphite film was produced in a manner similar to that in Example 2, except that 90 mol % of PMDA and 10 mol % of BPDA were used, instead of 100 mol % of PMDA, as acid dianhydride. In Example 7, a polyimide film having a thickness of 38 μm (birefringence: 0.113) was produced (Example 7→cure method: chemical cure method, average stretch ratio: 1.0).

### Example 8

A graphite film was produced in a manner similar to that in Example 2, except that 70 mol % of PMDA and 30 mol % of BPDA were used, instead of 100 mol % of PMDA, as acid dianhydride. In Example 8, a polyimide film having a thickness of 38 μm (birefringence: 0.110) was produced (Example 8→cure method: chemical cure method, average stretch ratio: 1.0).

### Example 9

A graphite film was produced in a manner similar to that in Example 1, except that 70 mol % of PMDA and 30 mol % of BPDA were used, instead of 100 mol % of PMDA, as acid dianhydride. In Example 9, a polyimide film having a thickness of 34 μm (birefringence: 0.110) was produced (Example 9→cure method: chemical cure method, average stretch ratio: 1.0).

### Example 10

A graphite film was produced in a manner similar to that in Example 3, except that 70 mol % of PMDA and 30 mol % of BPDA were used, instead of 100 mol % of PMDA, as acid dianhydride. In Example 10, a polyimide film having a thickness of 40 μm (birefringence: 0.110) was produced (Example 10→cure method: chemical cure method, average stretch ratio: 1.0).

### Example 11

A graphite film was produced in a manner similar to that in Example 2, except that 85 mol % of ODA and 15 mol % of PDA were used, instead of 100 mol % of ODA, as diamine. In Example 11, a polyimide film having a thickness of 38 μm (birefringence: 0.130) was produced (Example 11→cure method: chemical cure method, average stretch ratio: 1.0).

### Example 12

A graphite film was produced in a manner similar to that in Example 5, except that 70 mol % of ODA and 30 mol % of PDA were used, instead of 100 mol % of ODA, as diamine. In Example 12, a polyimide film having a thickness of 38 μm (birefringence: 0.130) was produced (Example 12→cure method: weak chemical cure method, average stretch ratio: 1.0).

### Example 13

A graphite film was produced in a manner similar to that in Example 1, except that (i) 70 mol % of ODA and 30 mol % of PDA were used, instead of 100 mol % of ODA, as diamine and (ii) in a step, during production of a polyimide film, of adding an imidization catalyst, containing acetic anhydride, isoquinoline, and DMF, so as to defoam a solution containing a polyamide acid, each of the acetic anhydride and the isoquinoline was in an amount of 0.7 equivalent with respect to a carboxylic acid group contained in the polyamide acid. Drying conditions were as follows. In Example 13, a polyimide film having a thickness of 34 μm (birefringence: 0.130) was produced (Example 13→cure method: weak chemical cure method, average stretch ratio: 1.0).

### Example 14

A graphite film was produced in a manner similar to that in Example 3, except that (i) 70 mol % of ODA and 30 mol % of PDA were used, instead of 100 mol % of ODA, as diamine and (ii) in a step, during production of a polyimide film, of adding an imidization catalyst, containing acetic anhydride, isoquinoline, and DMF, so as to defoam a solution containing a polyamide acid, each of the acetic anhydride and the isoquinoline was in an amount of 0.7 equivalent with respect to a carboxylic acid group contained in the polyamide acid. In Example 14, a polyimide film having a thickness of 40 μm (birefringence: 0.130) was produced (Example 14→cure method: weak chemical cure method, average stretch ratio: 1.0).

### Example 15

A graphite film was produced in a manner similar to that in Example 5, except that (i) 70 mol % of PMDA and 30 mol % of BPDA were used, instead of 100 mol % of PMDA, as acid dianhydride and (ii) 70 mol % of ODA and 30 mol % of PDA were used, instead of 100 mol % of ODA, as diamine. In Example 15, a polyimide film having a thickness of 38 μm (birefringence: 0.130) was produced (Example 15→cure method: weak chemical cure method, average stretch ratio: 1.0).

### Example 16

A graphite film was produced in a manner similar to that in Example 2, except that (i) 90 mol % of PMDA and 10 mol % of BPDA were used, instead of 100 mol % of PMDA, as acid dianhydride and (ii) 90 mol % of ODA and 10 mol % of PDA were used, instead of 100 mol % of ODA, as diamine. In Example 16, a polyimide film having a thickness of 38 μm (birefringence: 0.130) was produced (Example 16→cure method: chemical cure method, average stretch ratio: 1.0).

### Example 17

A graphite film was produced in a manner similar to that in Example 2, except that, in a step of fixing, to a frame, a gel film which had not been dried, the gel film was stretched so as to be 0.8 times larger in size in both of TD and MD directions and was then fixed to the frame. In Example 17, a polyimide film having a thickness of 38 μm (birefringence: 0.108) was produced (Example 17→cure method: chemical cure method, average stretch ratio: 0.8).

### Example 18

A graphite film was produced in a manner similar to that in Example 2, except that, in a step of fixing, to a frame, a gel film which had not been dried, the gel film was stretched so as to be 1.25 times larger in size in both of TD and MD directions and was then fixed to the frame. In Example 18, a polyimide film having a thickness of 38 μm (birefringence: 0.124) was produced (Example 18→cure method: chemical cure method, average stretch ratio: 1.25).

### Example 19

A graphite film was produced in a manner similar to that in Example 2, except that compression treatment was carried out three times (Example 19→cure method: chemical cure method, average stretch ratio: 1.0).

### Comparative Example 1

A graphite film was produced in a manner similar to that in Example 1, except that (i) a polyimide film having a thickness of 25 μm was used and (ii) drying conditions were set as follows. That is, a mixed solution layer on an aluminum foil was first dried at 120° C. for 80 seconds in a hot-air oven so as to obtain a gel film having a self-supporting property. The gel film was then removed from the aluminum foil and was fixed to a frame. Thereafter, the gel film was dried by heating the gel film in stages, that is, by heating the gel film at 120° C. for 10 seconds, at 275° C. for 13 seconds, at 400° C. for 14 seconds, and at 450° C. for 17 seconds in the hot-air oven and then heating the gel film at 460° C. for 8 seconds with use of a far-infrared heater. A polyimide film having a thickness of 25 μm (birefringence: 0.115) was thus produced (Comparative Example 1→cure method: chemical cure method, average stretch ratio: 1.00).

### Comparative Example 2

A graphite film was produced in a manner similar to that in Example 1, except that (i) a polyimide film having a thickness of 46 μm was used and (ii) drying conditions were set as follows. That is, a mixed solution layer on an aluminum foil was first dried at 120° C. for 148 seconds in a hot-air oven so as to obtain a gel film having a self-supporting property. The gel film was then removed from the aluminum foil and was fixed to a frame. Thereafter, the gel film was dried by heating the gel film in stages, that is, by heating the gel film at 120° C. for 18 seconds, at 275° C. for 25 seconds, at 400° C. for 26 seconds, and at 450° C. for 30 seconds in the hot-air oven and then heating the gel film at 460° C. for 14 seconds with use of a far-infrared heater. A polyimide film having a thickness of 46 μm (birefringence: 0.115) was thus produced (Comparative Example 2→cure method: chemical cure method, average stretch ratio: 1.00).

### Comparative Example 3

A graphite film was produced in a manner similar to that in Example 1, except that (i) a polyimide film having a thickness of 50 μm was used and (ii) drying conditions were set as follows. That is, a mixed solution layer on an aluminum foil was first dried at 120° C. for 160 seconds in a hot-air oven so as to obtain a gel film having a self-supporting property. The gel film was then removed from the aluminum foil and was fixed to a frame. Thereafter, the gel film was dried by heating the gel film in stages, that is, by heating the gel film at 120° C. for 20 seconds, at 275° C. for 27 seconds, at 400° C. for 29 seconds, and at 450° C. for 33 seconds in the hot-air oven and then heating the gel film at 460° C. for 15 seconds with use of a far-infrared heater. A polyimide film having a thickness of 50 μm (birefringence: 0.115) was thus produced (Comparative Example 3→cure method: chemical cure method, average stretch ratio: 1.00).

### Comparative Example 4

A graphite film was produced in a manner similar to that in Example 2, except that a polyimide film (birefringence: 0.149) having a thickness of 37 μm was produced with use of (a) 65 mol % of PMDA and 35 mol % of BPDA as an acid dianhydride component and (b) 85 mol % of ODA and 15 mol % of PDA as a diamine component (Comparative Example 4→cure method: chemical cure method, average stretch ratio: 1.0).

### Comparative Example 5

A graphite film was produced in a manner similar to that in Example 2, except that 65 mol % of ODA and 35 mol % of BPDA were used, instead of 100 mol % of ODA, as diamine. In Comparative Example 5, a polyimide film having a thickness of 38 μm (birefringence: 0.150) was produced (Comparative Example 5→cure method: chemical cure method, average stretch ratio: 1.0).

### Comparative Example 6

A graphite film was produced in a manner similar to that in Example 2, except that, in a step of fixing, to a frame, a gel film which had not been dried, the gel film was stretched so as to be 0.7 times larger in size in both of TD and MD directions and was then fixed to the frame. In Comparative Example 6, a polyimide film having a thickness of 38 μm (birefringence: 0.085) was produced (Comparative Example 6→cure method: chemical cure method, average stretch ratio: 0.7).

### Comparative Example 7

A graphite film was produced in a manner similar to that in Example 1, except that a polyimide film obtained in the following manner was used. That is, acid dianhydride composed of 100 mol % of PMDA was dissolved in a dimethylformamide (DMF) solution, in which diamine composed of 100 mol % of ODA was dissolved, so that the acid dianhydride was equal in molar quantity to the diamine. A solution containing 18.5 wt % of a polyamide acid was thus obtained. This solution was then defoamed and was applied on an aluminum foil so that a resultant polyimide film would have a thickness of 40 μm after the solution is dried. A mixed solution layer on the aluminum foil was dried in a hot-air oven.

Drying conditions were as follows. That is, the mixed solution layer on the aluminum foil was first dried at 120° C. for 5 minutes in the hot-air oven so as to obtain a gel film having a self-supporting property. This gel film was biaxially stretched so as to be 1.5 times larger in size in a TD direction and 1.3 times larger in size in a MD direction, and was then fixed to a frame. Thereafter, the gel film was dried by heating the gel film from 120° C. to 400° C. for 30 minutes in the hot-air oven. A polyimide film having a thickness of 40 μm (birefringence: 0.090) was thus produced (Comparative Example 7→cure method: chemical cure method, average stretch ratio: 1.4).

### Comparative Example 8

A graphite film was produced in a manner similar to that in Comparative Example 7, except that, in a step of fixing, to a frame, a gel film which had not been dried, the gel film was stretched so as to be 1.1 times larger in size in both of TD and MD directions and was then fixed to the frame. In Comparative Example 8, a polyimide film having a thickness of 40 μm (birefringence: 0.080) was produced (Comparative Example 8→cure method: thermal cure method, average stretch ratio: 1.1).

### Comparative Example 9

A graphite film was produced in a manner similar to that in Comparative Example 7, except that (i) a polyamide acid was applied on an aluminum foil so that a resultant polyimide film would have a thickness of 38 μm after the polyamide acid is dried, (ii) no stretch was carried out, and (iii) drying conditions were set as follows. That is, a mixed solution layer on the aluminum foil was dried at 120° C. for 4 minutes and 45 seconds in a hot-air oven so as to obtain a gel film having a self-supporting property. The gel film was fixed to a frame, and was then dried by heating the gel film from 120° C. to 400° C. for 28 minutes and 30 seconds in the hot-air oven. A polyimide film having a thickness of 38 μm (birefringence: 0.078) was thus produced (Comparative Example 9→cure method: thermal cure method, average stretch ratio: 1.0).

### Comparative Example 10

A graphite film was produced in a manner similar to that in Comparative Example 9, except that, in a step of fixing, to a frame, a gel film which had not been dried, the gel film was stretched so as to be 1.7 times larger in size in both of TD and MD directions and was then fixed to the frame. In Comparative Example 10, a polyimide film having a thickness of 38 μm (birefringence: 0.095) was produced (Comparative Example 10→cure method: chemical cure method, average stretch ratio: 1.7).

Table 1 below shows production conditions and physical properties of graphite films obtained in Examples and Comparative Examples.

TABLE 1

| | | | | | | | Physical Properties of graphite film | | | |
|---|---|---|---|---|---|---|---|---|---|---|
| | | | | | | | | | | Heat |
| | Physical properties of polyimide film | | | | | | | Heat | | diffusivity |
| | Thickness | Monomer | | | | | Thickness | diffusivity | Density | after |
| | (μm) | PMDA | BPDA | ODA | PDA | Birefringence | (μm) | (cm²/s) | (g/cm³) | bending |
| Example 1 | 34 | 100 | 0 | 10 | 0 | 0.115 | 14 | 9.3 | 1.90 | ○ |
| Example 2 | 38 | 100 | 0 | 100 | 0 | 0.115 | 16 | 9.6 | 1.91 | ○ |
| Example 3 | 40 | 100 | 0 | 100 | 0 | 0.115 | 17.5 | 9.4 | 1.90 | ○ |
| Example 4 | 42 | 100 | 0 | 100 | 0 | 0.115 | 18 | 9.3 | 1.90 | ○ |
| Example 5 | 38 | 100 | 0 | 100 | 0 | 0.104 | 16 | 9.4 | 1.90 | ○ |
| Example 6 | 38 | 100 | 0 | 100 | 0 | 0.100 | 16 | 9.3 | 1.85 | ○ |
| Example 7 | 38 | 90 | 10 | 100 | 0 | 0.113 | 16 | 9.6 | 1.90 | ○ |
| Example 8 | 38 | 70 | 30 | 100 | 0 | 0.110 | 16 | 9.6 | 1.89 | ○ |
| Example 9 | 34 | 70 | 30 | 100 | 0 | 0.110 | 14 | 9.4 | 1.88 | ○ |
| Example 10 | 40 | 70 | 30 | 100 | 0 | 0.110 | 18 | 9.3 | 1.87 | ○ |
| Example 11 | 38 | 100 | 0 | 85 | 15 | 0.130 | 16 | 9.2 | 1.85 | ○ |
| Example 12 | 38 | 100 | 0 | 70 | 30 | 0.130 | 16 | 9.6 | 1.89 | ○ |
| Example 13 | 34 | 100 | 0 | 70 | 30 | 0.130 | 14 | 9.4 | 1.87 | ○ |
| Example 14 | 40 | 100 | 0 | 70 | 30 | 0.130 | 18 | 9.3 | 1.87 | ○ |
| Example 15 | 38 | 70 | 30 | 70 | 30 | 0.130 | 16 | 9.6 | 1.89 | ○ |
| Example 16 | 38 | 90 | 10 | 90 | 10 | 0.130 | 16 | 9.4 | 1.87 | ○ |
| Example 17 | 38 | 100 | 0 | 100 | 0 | 0.108 | 16 | 9.2 | 1.90 | ○ |
| Example 18 | 38 | 100 | 0 | 100 | 0 | 0.124 | 15 | 9.0 | 1.85 | ○ |
| Example 19 | 38 | 100 | 0 | 100 | 0 | 0.115 | 15 | 9.6 | 2.07 | ○ |
| Comparative | 25 | 100 | 0 | 100 | 0 | 0.115 | 11 | 8.9 | 1.90 | ○ |
| Example 1 | | | | | | | | | | |
| Comparative | 46 | 100 | 0 | 100 | 0 | 0.115 | 20 | 8.8 | 1.88 | ○ |
| Example 2 | | | | | | | | | | |
| Comparative | 50 | 100 | 0 | 100 | 0 | 0.115 | 22 | 8.8 | 1.87 | ○ |
| Example 3 | | | | | | | | | | |
| Comparative | 37 | 65 | 35 | 85 | 15 | 0.149 | 17 | 8.6 | 1.80 | ○ |
| Example 4 | | | | | | | | | | |
| Comparative | 38 | 100 | 0 | 65 | 35 | 0.150 | 20 | 8.5 | 1.80 | ○ |
| Example 5 | | | | | | | | | | |
| Comparative | 38 | 100 | 0 | 100 | 0 | 0.085 | 16 | 8.0 | 1.80 | ○ |
| Example 6 | | | | | | | | | | |
| Comparative | 40 | 100 | 0 | 100 | 0 | 0.090 | 15 | 7.9 | 1.78 | ○ |
| Example 7 | | | | | | | | | | |
| Comparative | 40 | 100 | 0 | 100 | 0 | 0.080 | 16 | 7.7 | 1.75 | ○ |
| Example 8 | | | | | | | | | | |
| Comparative | 38 | 100 | 0 | 100 | 0 | 0.078 | 16 | 7.5 | 1.73 | ○ |
| Example 9 | | | | | | | | | | |
| Comparative | 38 | 100 | 0 | 100 | 0 | 0.095 | 15 | 7.9 | 1.80 | ○ |
| Example 10 | | | | | | | | | | |

<Thickness of Polyimide Film>

Comparison between Examples 1 through 4 and Comparative Examples 1 through 3 shows the following. In a case where a polyimide film having a thickness of not less than 34 μm and not more than 42 μm was used as a material, a resultant graphite film had a high thermal diffusivity of not less than 9.3 cm²/s. In a case where a polyimide film having a thickness of 38 μm was used as with Example 2, a resultant graphite film had a significantly high thermal diffusivity of 9.6 cm²/s.

In contrast, in a case where (i) a polyimide film having a thickness of 25 μm was used as with Comparative Example 1 or (ii) a polyimide film having a thickness of not less than 46 μm was used as with Comparative Examples 2 and 3, a resultant graphite film had a low thermal diffusivity of not more than 8.9 cm²/s.

From Examples 1 through 4, 8 through 10, and 12 through 14, it was revealed that, in view of obtaining an intended graphite film, a preferable thickness of a polyimide film tends to fall within the same range and that the most preferable thickness is 38 μm.

<Birefringence>

In Examples 1 through 19, the polyimide film had a birefringence of not less than 0.100 and not more than 0.130. In a case where the polyimide film according to any one of Examples 1 through 19 was used, it was possible to obtain a graphite film having a high thermal diffusivity (specifically, a thermal diffusivity of not less than 9.0).

In Comparative Examples 4 and 5, the polyimide film never had a birefringence of not less than 0.100 and not more than 0.130 (specifically, the polyimide film had a birefringence of not less than 0.149). In a case where the polyimide film according to Comparative Example 4 or 5 was used, only a graphite film having a low thermal diffusivity was obtained (specifically, a thermal diffusivity of not more than 8.6).

In Comparative Examples 6 through 10, the polyimide film never had a birefringence of not less than 0.100 and not more than 0.130 (specifically, the polyimide film had a birefringence of not more than 0.095). In a case where the polyimide film according to any one of Comparative Examples 6 through 10 was used, only a graphite film having a low thermal diffusivity was obtained (specifically, a thermal diffusivity of not more than 8.0).

<Compression Treatment to Graphite Film>

Comparison between Example 19 and the other Examples (particularly, Example 2) shows the following. In Example 19, the compression treatment was carried out three times (in Example 2, only once) with respect to the graphite film obtained by heat-treating the polyimide film. As is clear from Table 1, it was found that (i) a density of the graphite film ultimately obtained in Example 19 increased to 2.07 g/cm³ and (ii) the graphite film ultimately obtained in Example 19 was identical in thermal diffusivity (9.6 cm²/s) to that obtained in Example 2. That is, it was found that, even in a case where the compression treatment is carried out a plurality of times so that an ultimately obtained graphite film will have a high density, it is possible to obtain a graphite film having a high thermal diffusivity. Further, no change was observed in thermal diffusivity even in a case where the graphite film of any one of Examples was bent so as to have curvature whose radius was 2 mm.

### INDUSTRIAL APPLICABILITY

A graphite film produced by the method of the present invention has a thermal diffusivity higher than that of a conventional graphite film which is generally used as a heat dissipating component that can be provided in small-sized electronic devices and the like, and is more excellent in heat conductivity than the conventional graphite film.

Therefore, the graphite film produced by the method of the present invention can be used as a heat dissipating material or a heat dissipating component of electronic devices and the like.

1. A method of producing a graphite film having a thermal diffusivity of not less than 9.0 cm²/s, the method comprising:
heat-treating, at a temperature of not lower than 2,400° C., a polyimide film or a carbonized film obtained by carbonizing the polyimide film,
the polyimide film having (i) a thickness of not less than 34 μm and not more than 42 μm and (ii) a birefringence of not less than 0.100 and not more than 0.130.

2. The method as set forth in claim 1, wherein the polyimide film is a polyimide film obtained with use of (a) an acid dianhydride component containing not less than 70 mol % of pyromellitic acid dianhydride (PMDA) and (b) a diamine component containing not less than 70 mol % of 4,4′-diaminodiphenyl ether (ODA).

3. The method as set forth in claim 1, wherein the polyimide film is obtained by a chemical cure method.

4. The method as set forth in claim 1, wherein the polyimide film has an average stretch ratio of not less than 0.8 and not more than 1.25 in each of MD and TD directions.

5. A method of producing a graphite film, the method comprising:
heat-treating, at a temperature of not lower than 2,400° C., a polyimide film or a carbonized film obtained by carbonizing the polyimide film,
the polyamide film having (i) a thickness of not less than 34 μm and not more than 42 μm and (ii) a birefringence of not less than 0.100 and not more than 0.130,
the polyimide film or the carbonized film being heat-treated in a state where the polyimide film or the carbonized film is alternately layered with a carbonaceous sheet.

6. The method as set forth in claim 5, wherein the polyimide film is a polyimide film obtained with use of (a) an acid dianhydride component containing not less than 70 mol % of pyromellitic acid dianhydride (PMDA) and (b) a diamine component containing not less than 70 mol % of 4,4′-diaminodiphenyl ether (ODA).

7. The method as set forth in claim 5, wherein the polyimide film is obtained by a chemical cure method.

8. The method as set forth in claim 5, wherein the polyimide film has an average stretch ratio of not less than 0.8 and not more than 1.25 in each of MD and TD directions.

9. A method of producing a graphite film, the method comprising:
heat-treating, at a temperature of not lower than 2,400° C., a polyimide film or a carbonized film obtained by carbonizing the polyimide film,
the polyimide film having (i) a thickness of 38 μm and (ii) a birefringence of not less than 0.100 and not more than 0.130.

10. The method as set forth in claim 9, wherein the polyimide film is a polyimide film obtained with use of (a) an acid dianhydride component containing not less than 70 mol % of pyromellitic acid dianhydride (PMDA) and (b) a diamine component containing not less than 70 mol % of 4,4′-diaminodiphenyl ether (ODA).

11. The method as set forth in claim 9, wherein the polyimide film is obtained by a chemical cure method.

12. The method as set forth in claim 9, wherein the polyimide film has an average stretch ratio of not less than 0.8 and not more than 1.25 in each of MD and TD directions.

13. A graphite film having:
a thickness of not less than 14 μm and not more than 18 μm;
a thermal diffusivity of not less than 9.0 cm²/s; and
a density of not less than 1.8 g/cm³.
